(19) United States
(12) Patent Application Publication
(10) Pub. No.: US 2016/0326040 A1
(43) Pub. Date: Nov. 10, 2016

(54) GLASS-MAKING-QUALITY GRANULATED SLAG PROCESS

(71) Applicants: Peter Beemsterboer, Chicago, IL (US); Simon Beemsterboer, Chicago, IL (US); Francis A. Lesters, Naperville, IL (US)

(72) Inventors: Peter Beemsterboer, Chicago, IL (US); Simon Beemsterboer, Chicago, IL (US); Francis A. Lesters, Naperville, IL (US)

(21) Appl. No.: 15/146,703

(22) Filed: May 4, 2016

Related U.S. Application Data
(60) Provisional application No. 62/156,607, filed on May 4, 2015.

(51) Int. Cl. C03B 37/005; C03C 1/02; C03C 1/00

(52) U.S. Cl. CPC C03B 37/005; C03C 1/002; C03C 1/026

(57) ABSTRACT

Glass-making-quality granulated slag particles can be defined within a certain particle size range. A process for forming glass-making-quality granulated slag includes collecting a molten slag flow, cold-water quenching the molten slag flow to create a granulated slag flow, drying the granulated slag flow, and size-screening the granulated slag flow to separate conforming glass-making-quality granulated slag from the granulated slag flow. The process can include using at least one magnetic device to separate ferrous contaminants from the granulated slag flow.

### CROSS REFERENCE TO RELATED APPLICATIONS

This disclosure claims the benefit of U.S. Provisional Application No. 62/156,607 filed on May 4, 2015 which is hereby incorporated by reference.

### TECHNICAL FIELD

This disclosure is related to a process for creating glass-making-quality granulated slag, an additive for the making of glass into flat sheets and containers.

### BACKGROUND

The statements in this section merely provide background information related to the present disclosure. Accordingly, such statements are not intended to constitute an admission of prior art.

Slag is a by-product of the creation of iron and other metals from ore. Slag is a mixture of stony products, metal fragments including iron and alumina, silica, and other materials. One common use of ground granulated blast furnace slag is the production of blended cements, using properties of the slag to improve upon the properties of common Portland cement.

Another, less-utilized use for slag is the production of glass products. However, glass products using slag as an ingredient are sensitive to alumina and silica contaminants. Glass made with contaminated slag can cause pocks, voids, and other weaknesses. Further, slag particle size can affect the quality and ease of manufacture of glass products. Particles that are too large can weaken the glass. Particles that are too small or are essentially slag dust are very difficult and/or hazardous to deal with as they tend to create a cloud of particles in the air upon delivery and handling at the glass maker's facility.

Methods to create slag particles in particular size range include taking an already cooled slag and crushing the slag.

### SUMMARY

Glass-making-quality granulated slag particles can be defined within a certain particle size range. A process for forming glass-making-quality granulated slag includes collecting a molten slag flow, cold-water quenching the molten slag flow to create a granulated slag flow, drying the granulated slag flow, and size-screening the granulated slag flow to separate conforming glass-making-quality granulated slag from the granulated slag flow. The process can include using at least one magnetic device to separate ferrous contaminants from the granulated slag flow.

### BRIEF DESCRIPTION OF THE DRAWINGS

One or more embodiments will now be described, by way of example, with reference to the accompanying drawings, in which:

FIG. 1 illustrates a process flow chart for an exemplary process to create glass-making-quality granulated slag, in accordance with the present disclosure;

FIG. 2 illustrates a process flow chart for an alternative exemplary process to create glass-making-quality granulated slag, in accordance with the present disclosure;

FIG. 3 illustrates exemplary machinery accomplishing quenching steps of the disclosed process, in accordance with the present disclosure;

FIG. 4 illustrates exemplary machinery accomplishing plant operation steps of the disclosed process, in accordance with the present disclosure; and

FIG. 5 illustrates an exemplary rotary drum magnet device, in accordance with the present disclosure.

### DETAILED DESCRIPTION

A unique process has been developed to utilize a special type of blast furnace slag called glass-making-quality granulated slag coming from an exemplary iron making facility. For the purposes of this disclosure, an embodiment of the glass-making-quality granulated slag can be labeled or described by the product name Vitrafine™. This glass-making-quality granulated slag has most of the metal and alumina contaminants removed and has been selected/sorted for particles in a conforming contaminant range.

An exemplary process for creating conforming glass-making-quality granulated slag from a flow of untreated slag. In a first step of the exemplary process, the process begins with collecting the slag and determining slag chemistry appropriate for production of the desired glass-making-quality granulated slag.

An exemplary sub-set of steps to collect and certify molten slag from a blast furnace creating iron is provided. The molten slag is tapped from a notched hole in the bottom of the furnace and begins to flow down a ceramic trough in a liquid state of approximately 2500 degrees Fahrenheit which is verified by the operator. The trough is made up of various hard, heat and wear-resistant materials cast in a U-shape and sloped to promote gravity flow. Attention to the chemical and physical properties as well as when replacement and repair of these runners take place is critical. At repair and replacement time the hardened minerals loosen from the runner and increase in the slag product contaminating it when it is water quenched. The chemistry of the slag must be examined to determine whether the slag is a conforming unprocessed slag capable of being utilized for glass-making-quality granulated slag. If large concentrations of contaminants are determined to be present, whether from the iron making process or from the runner, the product is determined to be non-conforming slag and aborted for other purposes.

In a next step of the exemplary process, beginning a sub-set of process steps which can be labeled the quenching steps, the slag must be provided from the smelting process in a temperature range of between 2,500° F.-2600 ° F.

Once the molten blast furnace slag reaches the cooling box sprays, which provide ten (10) times the water volume to slag, it causes the slag to expand and crystallize into what is called granulated slag. The liquid slag is water-quenched instantly into a solid state. Adequate water flow and substantially cold water ideally in the range of 150° F.-170° F. is important to generate adequate generation of slag particles in the desired size and shape range. The coolant water needs to be below 200° F. to be effective. Knowledge of the slag temperature and replacement water volume is critical to the cooling water temperature. Low temperatures do not produce the proper product for further processing at the plant and will have to be aborted.

Attention is required of the cooling water temperature so as to have a consistent quenching of the slag for further processing in the plant. The amount of water circulation change needs to be monitored from that which is relieved as steam and that which is evacuated to the water treatment facility and returned as cooled replacement water.

The granulated slag, wet from the quenching process, goes through a rotating drum to be dewatered and then is transported to a dewatering silo. In an optional stage, the quenched slag mixed with water can be filtered or screen separated, removing undersized particles from the slag mixture while the slag particles are still mixed with the quenching water. In this way, many fine particles are removed with the water going to the water treatment facility which removes many contaminated fines that do not meet the separation criteria.

In a next step of the exemplary process, a quality check can be performed upon the quenched slag from the previous step. Visual acceptance is first utilized as discolored material is the sign of an inferior product. In one embodiment, samples of the granulated slag are taken and reviewed by a laboratory to determine a number of contaminants in the sample. If the slag meets the noted criteria it is considered acceptable for plant processing and the quenching steps can be considered complete. Upon determination of required quality parameters of the slag from the blast furnace granulation process, the slag is labeled as premium granulated slag, stockpiled, and ready for processing in the Vitrafine™ plant.

In a next step of the exemplary process, the stockpiled premium granulated slag dewaters further in the stockpile for several days before being loaded by an exemplary end-loader to a plant reservoir called a bin.

In a next step of the exemplary process, beginning a sub-set of process steps which can be labeled as plant operation steps, a first plant operation step is introduction into an exemplary natural gas rotary drum dryer moisture. This dried slag flow can optionally be screened at this point, for example, with a particle screen, for grossly oversized particles.

In treating slag flows that include an iron contaminant content, optional plant operation steps can be initiated to remove the iron contaminants. In one exemplary step to achieve separation of iron particles from the slag flow, one or more rare earth rotary drum magnets are in the flow. Magnetic particles are strongly attracted to the drum surface and removed from the slag flow. The iron particles once beyond the magnetic field of the drum magnet are then separated from the drum. for further processing.

The drum magnets are designed to efficiently separate iron particles by placement of the magnetic rare earth magnets within the drum. The magnetic material utilized inside the drums are a specially made magnet that can withstand high heat without losing the magnet properties.

While alumina and other non-ferrous particles are not attracted to the magnetic drums, testing has found that the iron particles removed by the drums tend to also include other contaminants. By separating out the ferrous particles, the other contaminants are largely removed as well.

A next plant operation step includes transferring the dried slag material to a separating device or devices configured to separate conforming slag particles of the desired size and shape from non-conforming particles. In one exemplary configuration to accomplish this separation, a bucket elevator takes the slag to a splitter tube that distributes the material over two exemplary Midwest 4 deck vibratory screens with rubber balls for increased screening capacity that separate specifically sized gradation material into a finished product that is 24 mesh by 140 mesh. Oversized and undersized materials are separated from conforming material, which can then be transported pneumatically to a storage silo for shipping. Material not meeting the specific size can be separated into larger than 24 mesh and smaller than 140 mesh for reprocessing or marketing into other products. In one optional embodiment of the process, the rejected slag material labeled as larger than 24 mesh flows into a crusher device for further size reduction and recirculates back to the screens for separation repeating the separation step of the process. In one exemplary configuration, the crusher device has the capability of changing the rotation speed through a variable speed setting on the motor to minimize crushing the granulated slag to a size smaller than that which is required conforming slag.

In one exemplary process step, the smaller than 140 mesh material is pneumatically delivered to a silo for sales to alternate non-glass manufacturing facilities.

After the separation step, the plant operation steps end and the conforming slag flow from the separation process can be labeled as Vitrafine™ or glass-making-quality granulated slag. Additional testing can be performed to sub-classify the Vitrafine™ or confirm presence of contaminants that would cause a problem in the glassmaking process.

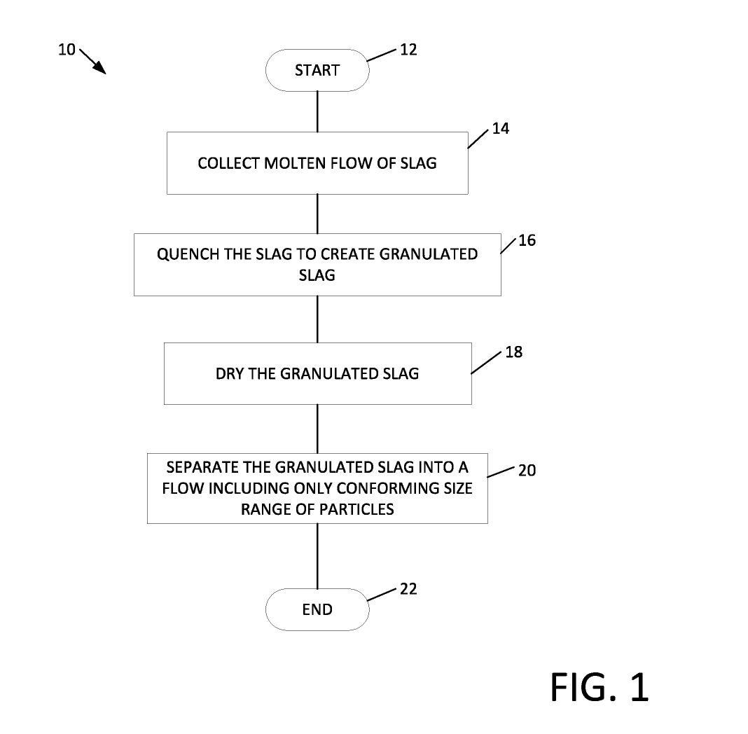

FIG. 1 illustrates a process flow chart for an exemplary process to create glass-making-quality granulated slag. Process 10 starts at step 12. At step 14, a molten flow of slag is collected. At step 16, the molten flow of slag is quenched rapidly to create a flow of granulated slag. At step 18, the granulated slag is dried. At step 20, the granulated slag is size-screened or separated according to size, providing a flow of conforming size slag particles. At step 22, process 10 ends.

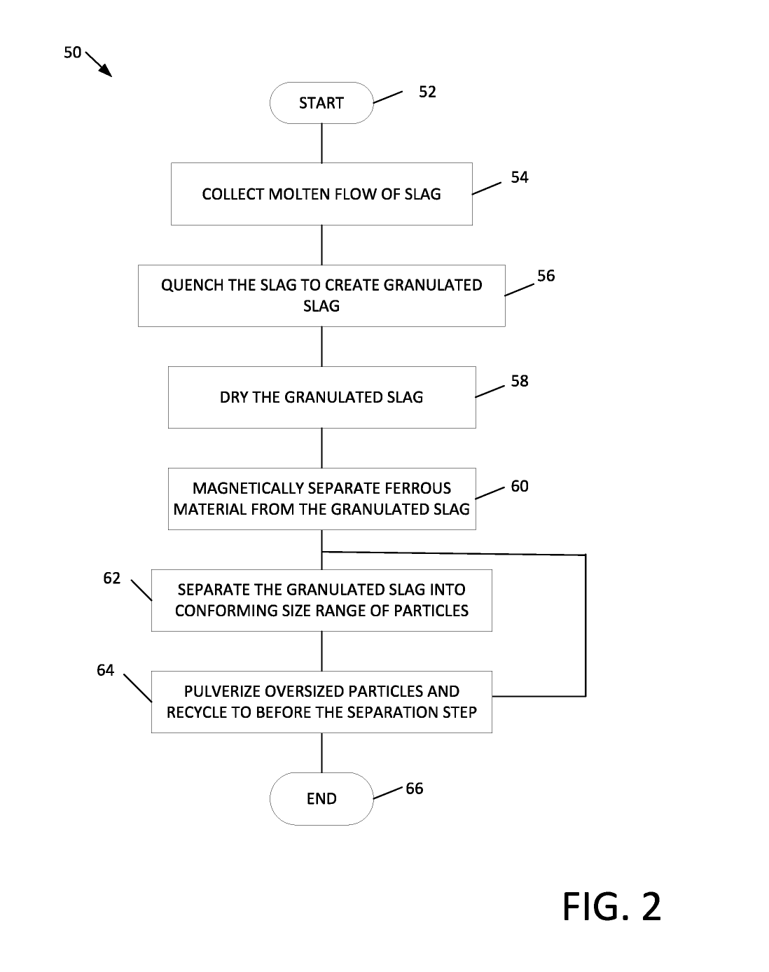

FIG. 2 illustrates a process flow chart for an alternative exemplary process to create glass-making-quality granulated slag. Process 50 starts at step 52. At step 54, a molten flow of slag is collected. At step 56, the molten flow of slag is quenched rapidly to create a flow of granulated slag. At step 58, the granulated slag is dried. At step 60, a magnetic device separates ferrous material from the granulated slag. At step 62, the granulated slag is size-screened or separated according to size, providing a flow of conforming size slag particles. At step 64, slag that was rejected at step 64 for being oversized is crushed and recycled to the size-screening process. At step 66, process 50 ends.

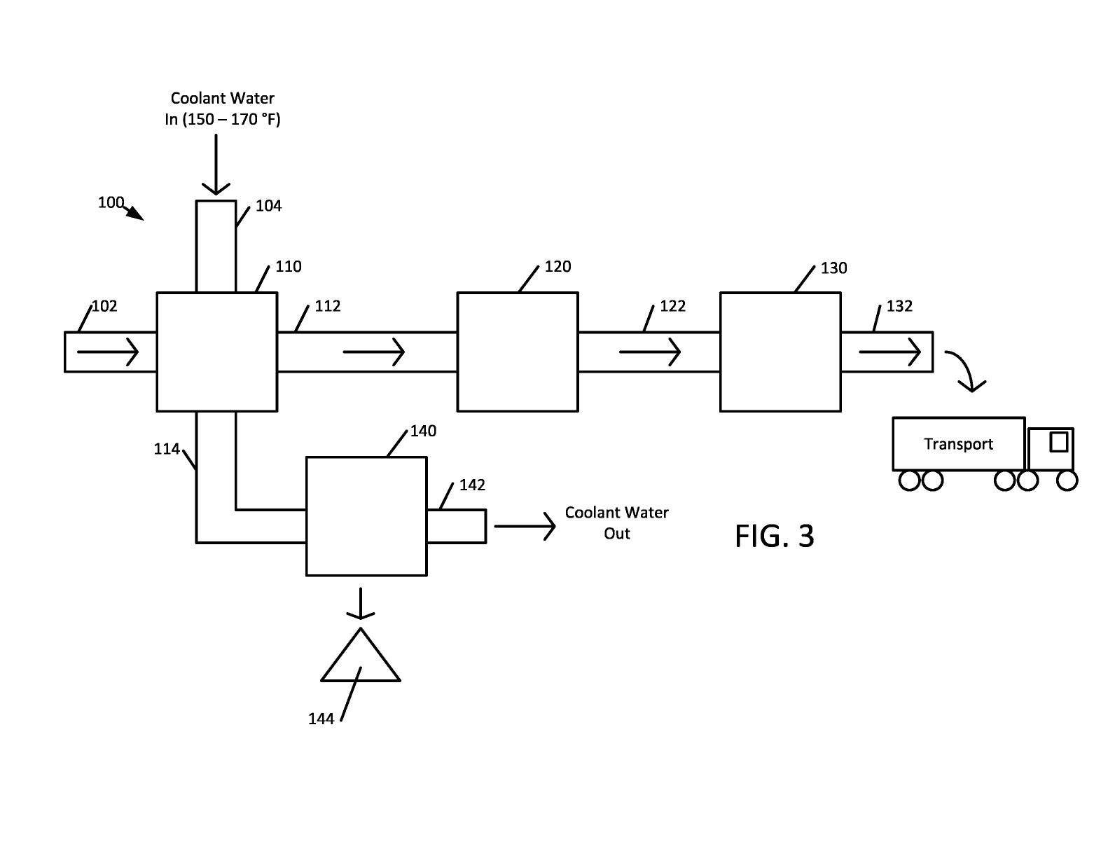

FIG. 3 illustrates exemplary machinery accomplishing quenching steps of the disclosed process. Quenching operation 100 is illustrated. Molten slag flow 102 is delivered to quenching station 110, wherein coolant water flow 104 is provided to very quickly cool the slag and created granulated slag according to the disclosure. Quenched slag flow 112 leaves station 110 and is transported to drying station 120. Post-quench coolant water flow 114 includes very fine slag particles that are picked up in the water during the quenching process. Flow 114 leaves station 110 and is delivered to filtering station 140 which provides filtered small slag particle stockpile 144 and filtered coolant water flow 142 to be conditioned and resupplied as flow 104. Drying station 120 receives quenched slag flow 112 and uses mechanisms such as a spinning drum and heat to separate water from the quenched slag and begin to dry the premium granulated slag flow. Premium granulated slag flow 122 leaves station 120 to be stockpiled at bin station 130, wherein the premium granulated slag is permitted to continue to dry in preparation for being loaded as flow 132 into transportation to an exemplary separate plant operation at a different physical location. In other embodiments, the plant operation can be in the same physical site as the quenching operation.

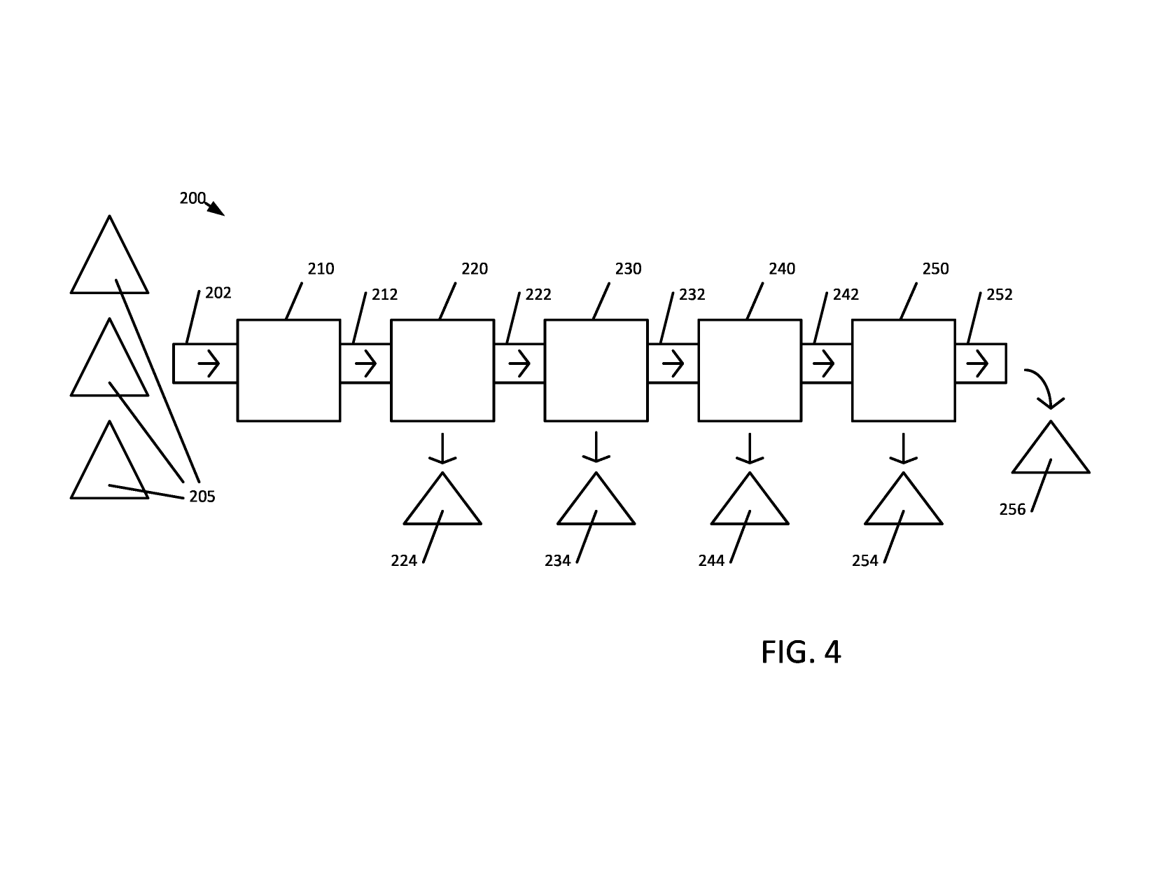

FIG. 4 illustrates exemplary machinery accomplishing plant operation steps of the disclosed process. Plant operation 200 is illustrated. Premium slag stockpiles 205 are illustrated including slag that was delivered from a quenching operation and is continuing to dry. Premium slag flow 202 is created by providing premium slag from stockpiles 205. Drying station 210 receives premium slag flow 202 and uses mechanisms such as a spinning drum and heat, such as can be supplied by using a natural gas burner or burners or similar devices, to complete drying the premium slag flow. Dried slag flow 212 leaves station 210 and is delivered to grossly oversized particle separation station 220 which separates out large particles from the dried slag flow and creates grossly oversized particle stockpile 224. In one exemplary embodiment, station 220 separates particles with a diameter greater than ⅜ inch from the slag flow. In one alternative embodiment, stations 220 and 210 can be reversed, with the grossly oversized particles being removed from the slag flow prior to drying, in order to avoid spending energy drying clearly rejected components of the slag flow. Slag flow 222 leaves station 220 and is delivered to magnetic drum station 230. Magnetic drum devices, in one exemplary embodiment, four rotary drum rare earth magnet devices, are put in station 230 within the slag flow to attract and remove from the flow ferrous particles that are attracted to the magnets. Station 230 provides ferrous particle stockpile 234. Slag flow 232 leaves station 230 and is delivered to large particle separation station 240, where mesh screens are used to separate particles that are larger than a desired glass-making-quality slag particle size range specification. Station 240 provides oversize slag particle stockpile 244. Slag flow 242 leaves station 240 and is delivered to small particle separation station 250. Mesh screens are used in station 250 to separate particles that are smaller than the desired glass-making-quality slag particle size range specification. Station 250 provides undersize slag particle stockpile 254. Conforming glass-making-quality slag flow 252 leaves station 250 to create glass-making-quality slag stockpile 256.

The stations of FIGS. 3 and 4 are exemplary. Many of the operations can be swapped in location with other operations or combined into mixed or multiple function stations in accordance with the disclosure. Stations can be eliminated, for example, with the grossly oversized particles and the oversize slag particles being separated from the premium slag flow at a single station or with a single screen in accordance with the disclosure.

The disclosed process provides 24 mesh and 140 mesh screens as useful for size-screening conforming slag particles. Other size meshes can be used depending upon the particular requirements of a glass manufacturer, and the disclosure is not intended to be limited to the particular mesh sizes provided. In another example, a large-side dimension for granulated slag particles can be 16 mesh instead of 24 mesh.

A rotary drum rare earth magnet device can be used to remove ferrous material from a granulated slag flow. Rare earth magnets can be sensitive to temperature. Depending upon the specific embodiment of the disclosed process, the temperature of the slag flow being processed by the magnet device can be too high for rotary drum magnet devices known in the art. In one exemplary embodiment, after slag is dried by a natural gas drying station, the temperature of the slag can be up to 300° F. An exemplary high temperature rotating drum and housing magnet capable of processing a flow up to 300° F. is provided with the following characteristics. A device outer housing can include 11 gauge 304 stainless steel construction, 28″×54″×33-⅛″ tall flange to flange with heavy duty predrilled 2″×2″×¼″ carbon steel angle flanges. The high temperature rotating drum and housing magnet can include rare earth Neodymium-Iron-Boron permanent magnet material for operating temperatures to 300° F. The high temperature rotating drum and housing magnet can include a magnetic field designed for high gauss at drum surface and low burden depth applications. The rotating drum can be 18″ diameter×48″ wide and fabricated with ⅛″ thick Nitronic 30 stainless steel for abrasion resistance. In another embodiment, the drum can be made with 3/16″ thick Nitronic 30 stainless steel. In another embodiment, the drum can be made with ⅛″ thick 304 stainless steel. The high temperature rotating drum and housing magnet can include an adjustable feed gate for product flow, wherein a slag flow inlet has fixed diverter to direct product flow over magnet area. A slag flow outlet can have an adjustable splitter for ferrous and non-ferrous product discharge. In one embodiment, a 230/460 Volt, 3 ph ¾ HP motor and reducer with variable frequency drive and controller can be used to drive rotation of the drum. A position of magnet or magnets within the drum can be adjustable for optimum separation. The high temperature rotating drum and housing magnet can include continuous cleaning discharges ferrous contaminants separate from product. In one embodiment, the drum shaft has a ½″ NPT (National Pipe Thread Taper) adjustable cooling air inlet on fixed end and outlet on drive end to assist in internal cooling of magnet assembly. There can be a dust cover on a drum cooling air inlet to avoid contamination within the drum. The cooling air inlet permits a cooling flow to flow through the magnet device and keep the device from overheating. In another exemplary construction, a water cooling flow can be channeled through the magnet device.

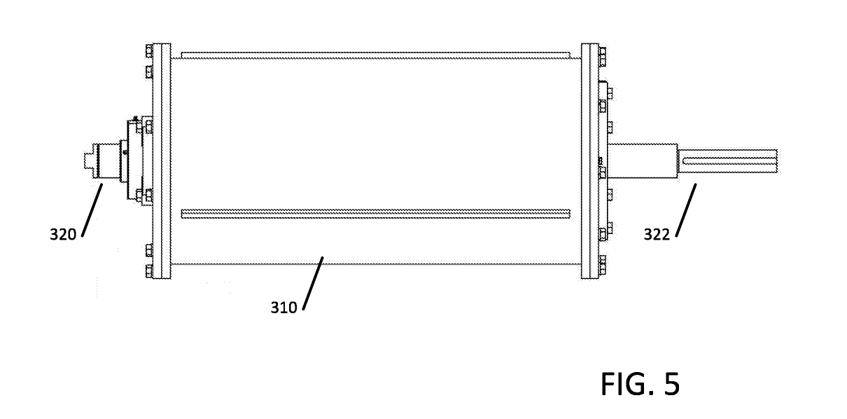

FIG. 5 illustrates an exemplary rotary drum magnet device. 310 illustrates a cylindrical outer drum surface that is placed in the slag flow. First shaft 320 and second shaft 322 are used to input torque to turn the drum and the associated magnets within the drum.

The disclosure has described certain preferred embodiments and modifications of those embodiments. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. A process for forming glass-making-quality granulated slag, the process comprising:
collecting a molten slag flow;
cold-water quenching the molten slag flow to create a granulated slag flow;
drying the granulated slag flow; and
size-screening the granulated slag flow to separate conforming glass-making-quality granulated slag from the granulated slag flow.

2. The process of claim 1, wherein size-screening comprises separating out slag particles smaller than 140 mesh.

3. The process of claim 2, wherein separating out slag particles smaller than 140 mesh comprises filtering out fine slag particles from coolant water used in the cold-water quenching.

4. The process of claim 1, wherein size-screening comprises separating out slag particles over ⅜ inches in diameter prior to drying the granulated slag flow.

5. The process of claim 1, wherein size-screening comprises separating out slag particles larger than 24 mesh.

6. The process of claim 5, further comprising:
crushing the slag particles larger than 24 mesh; and
recycling the crushed particles to the granulated slag flow for the size-screening.

7. The process of claim 1, wherein size-screening comprises separating out slag particles larger than 16 mesh.

8. The process of claim 1, wherein size-screening comprises separating out slag particles smaller than 140 mesh and larger than 24 mesh.

9. The process of claim 8, wherein separating out the slag particles comprises running the slag through at least one vibratory screen device.

10. The process of claim 9, wherein separating out the slag particles comprises running the slag through a plurality of vibratory screen devices, wherein at least one of the vibratory screen devices comprises agitating balls configured to bounce with the slag particles and facilitate separation of the slag particles from each other.

11. The process of claim 1, wherein the cold-quenching comprises quenching the molten slag flow with a water flow ten times a volume of the molten slag flow, wherein the water flow prior to the quenching has a temperature of not more than 200° F.

12. The process of claim 1, wherein the cold-quenching comprises quenching the molten slag flow with a water flow ten times a volume of the molten slag flow, wherein the water flow prior to the quenching has a temperature of between 150° F. and 170° F.

13. The process of claim 1, further comprising magnetically separating ferrous materials from the granulated slag with a magnet device.

14. The process of claim 13, further comprising providing a cooling flow through the magnet device to prevent the magnet device from overheating.

15. The process of claim 1, further comprising magnetically separating ferrous materials from the granulated slag with a plurality of rare earth drum magnet devices.

16. A process for forming glass-making-quality granulated slag, the process comprising:
collecting a molten slag flow;
cold-water quenching the molten slag flow with a water flow ten times the volume of the molten slag flow to create a granulated slag flow;
drying the granulated slag flow;
magnetically separating ferrous materials from the granulated slag with a rare earth drum magnet;
vibrating the granulated slag flow over size separating screens to separate the granulated slag flow, the vibrating comprising separating out non-conforming slag particles smaller than 140 mesh and larger than 24 mesh;
identifying slag particles larger than 140 mesh and smaller than 24 mesh as conforming glass-making-quality granulated slag.
